(19) United States
(12) Patent Application Publication
(10) Pub. No.: US 2003/0071483 A1
(43) Pub. Date: Apr. 17, 2003

(54) Frame assembly for mounting windows and/or doors in camper and truck caps

(76) Inventors: Kevin R. Sutton, Youngsville, NC (US); David M. Edwards, Kittrell, NC (US); Fred C. McGhee, Louisburg, NC (US)

Correspondence Address: OLIVE & OLIVE, P.A., 500 MEMORIAL STREET, PO BOX 2049, DURHAM, NC, 27702, US

(21) Appl. No.: 09/977,651

(22) Filed: Oct. 15, 2001

(51) Int. Cl. B60J 1/12

(52) U.S. Cl. 296/146.16

(57) ABSTRACT

The present invention is directed to mounting frame assembly for mounting one or more window and/or doors in an cut-out portion formed in a body panel of a vehicle, such as a truck or camper cap. The window mounting frame is shaped to fit around an edge of an opening formed in the cap. The window mounting frame has a clamping surface formed thereon. A clamping element is engaged with the clamping surface to hold the window mounting frame securely within the cut-out portion. The clamping element holds the window frame to the cap by frictional engagement of the cap wall between the inner face of the outer periphery of the cut-out portion and the clamping surface. The frictional engagement provides a secure and weather tight fit of the window mounting frame in the cap

### FIELD OF THE INVENTION

The present invention relates to a frame assembly for mounting windows, doors, and the like in a cutout section of a truck or camper cap. More particularly, the present invention is directed to a frame assembly having a clamping device or element that allows for the rapid installation of the frame assembly in a cutout in a cap for mounting windows, doors, and the like with minimized use of parts and labor.

### BACKGROUND OF THE INVENTION

The present invention provides a frame assembly that can be easily mounted in a window or door cutout of a truck or camper cap by a single individual.

Truck and camper caps are generally preformed pieces of substantially thin fiberglass or sheet metal that are affixed over the cargo bed area of a pickup truck. Generally, these caps after being formed and shaped are fitted with windows and/or doors placed in cutout areas. The cut-out areas of the cap can be preformed by various methods such as sawing, laser or water jet cutting or the like. A frame is usually inserted into each cutout portion of the cap. The frame is adapted to hold one or more window panes and/or a door. The frame is usually formed of extruded aluminum and when used as a window frame, has several tracks that carry window panes. The extruded aluminum frame is measured to a length proportionate to the periphery of the cut-out, and is bent into a predetermined shape, such as rectangular with radius corners, circular, square, etc., by a bending or braking machine.

Presently, shaped window and/or door frames are usually mounted on the cap in a manual fashion. It generally takes two individuals to assemble the window or door frame onto the cap. One individual positioned at an area outside of the cap, picks up a designated frame and positions it in the cut-out. A second individual positioned inside the cap then places a clamp ring around the periphery of the frame from the inside area of the cap, and fixes the frame in place as it is being held by the other individual by inserting a series of screws through the clamp ring around the periphery of the frame. Several screws are required to securely fasten the clamp ring to the frame and the frame to the cap. In order to ensure a weather-tight fit between the cap and frame, weather strips are usually included in the mounting process.

The presently used manual process is labor intensive and requires the efforts of multiple individuals to complete the task of installing the frame. This process is also time-consuming and can result in punctures of the frame by the screws being inserted, thereby causing leaks between the frame and the cap. Screw punctures also create an unsightly appearance to the outside of the frame, as do the presence of multiple screws on the interior of the frame. When adhesives are used in place of screws as is sometimes the practice, substantial time is still required to complete the installation.

What is desired and thus becomes the principal object of the invention is to provide a frame assembly adapted for mounting a window, door or the like that can be easily mounted in a cap by at the most two, and preferably one individual, and in a manner, which obviates the need for screws in order to both reduce the time necessary to install the frame assembly and reduce the unsightly presence of screws. Other objects and advantages will become apparent as the description proceeds or may be learned by practice of the invention.

### SUMMARY OF THE INVENTION

To achieve the foregoing object, the invention while applicable to mounting a window, door or the like, is illustrated and described, by way of example, as providing a window mounting frame assembly for mounting one or more window panes in an opening formed in a substantially thin body panel of a vehicle, such as a truck or camper cap. The window mounting frame assembly mounts and is installed within an opening formed in the typically thin wall of the cap. A substantially rigid mounting frame forming part of the assembly conforms to and mounts within a peripheral edge area of the opening. A flexible clamping element engages a clamping surface on the frame and holds the frame to the cap by frictional engagement. The frictional engagement provides a secure and weather tight fit of the frame in the cap.

### BRIEF DESCRIPTION OF THE DRAWINGS

In order that the invention will become more clearly understood it will be disclosed in greater detail with reference to the accompanying drawings, in which:

FIG. 1 is a fragmentary perspective view of a pickup truck having a cap positioned thereon and showing a set of windows installed in a window frame according to the invention;

FIG. 2 is an exploded cross-sectional view of a first embodiment of a window frame according to the present invention;

FIG. 3 is an enlarged assembled cross-sectional view of the first embodiment of a window frame according to the present invention taken along section line A-A in FIG. 1;

FIG. 4 is an exploded cross-sectional view of a second embodiment of a window frame according to the present invention;

FIG. 5 is an enlarged assembled cross-sectional view of the second embodiment of a window frame according to the present invention taken along section line A-A in FIG. 1;

FIG. 6 is an exploded cross-sectional view of a third embodiment of a window frame according to the present invention; and

FIG. 7 is an enlarged assembled cross-sectional view of the third embodiment of a window frame according to the present invention taken along section line A-A in FIG. 1.

### DESCRIPTION OF THE PREFERRED EMBODIMENT

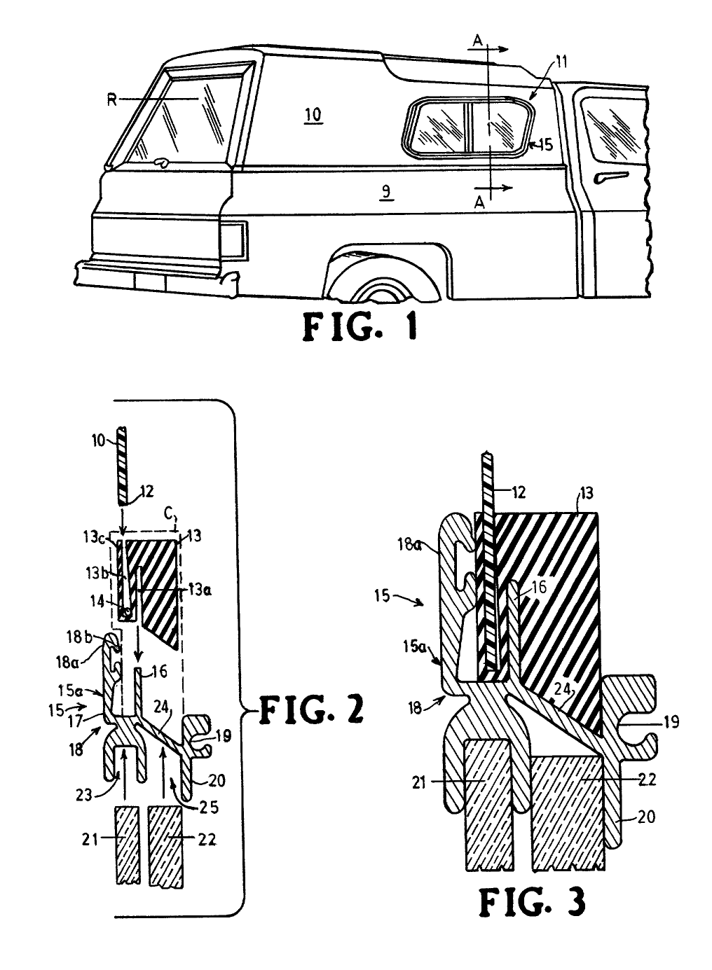

FIG. 1 illustrates a pickup truck with a bed 9 having a cap 10 assembled thereon. Cap 10 is illustrated with a side window 11, made up in the example used for illustration of two window panes, as later referred to, that includes a window frame assembly 15 that is mounted in a similarly shaped hole cut out of cap 10. While illustrated in a parallelogram orientation, window 11 could be of any size or shape in cap 10. In addition, similar door may be present at the rear R of the cap or window on the far side or front of the cap, not seen in FIG. 1. The present invention is directed to any such window frame which is used by way of example and as previously mentioned may also be applied to use as a frame for a door or the like.

FIG. 2 illustrates a cross-sectional exploded view of window frame assembly 15 for side window 11 according to a first embodiment of the present invention. Window frame assembly 15 can include many different features that are not illustrated here. However, for ease of describing the invention, only those features of window frame assembly 15 that are relevant to the present invention are illustrated. Window frame assembly 15 includes mounting frame 15a as indicated in FIGS. 2 and 3.

Mounting frame 15a includes an outer surface 18 that has an outer face 18a opposite an inner face 18b. Outer surface 18 and outer face 18a are visible on the outside of cap 10 when window frame assembly 15 is mounted on cap 10. Mounting frame 15a also includes an inner peripheral surface 20. As illustrated, inner peripheral surface 20 includes a screen jam 19 in which a screen (not shown) can be mounted. A connecting section 24 extends between the screen jam 19 and clamping surface 16. On the underside of connecting section 24, are receiving slots 23 and 25 in which are held window panes 21 and 22. Receiving slots 23 and 25 and window panes 21 and 22 are shown for illustrative purposes only, and may take several different forms. For example there could be a single window pane and receiving slot or be a plurality of receiving slots and panes. Mounting frame 15a is rigid and is usually made of aluminum. It can be formed in any known manner, such as through an extrusion process.

The present invention also includes a clamping arrangement, shown generally as those elements in the broken line box C of FIG. 2. The clamping arrangement includes the previously referred to clamping surface 16 integrally formed on the upper side of connecting section 24. In this embodiment, clamping surface 16 is in the form of a post formed relatively close to inner face 18b.

The clamping arrangement further comprises a generally flexible clamping element 13 adapted to come into frictional contact with clamping surface 16. Clamping element 13 includes two slots 13a and 13b. Slot 13a is designed to engage with clamping surface 16 on mounting frame 15a. Clamping element 13 can be made of a wide variety of materials, either rigid or pliable, but is preferably made of a pliable material such as plastic, rubber, neoprene, or Santoprene™. Clamping element 13 can come in a preformed shape with a slot 13b complimentary to the shape of the peripheral edge area 12 of cap 10. Alternatively, clamping element 13 can be made of a single length of material that is rolled onto a spool or otherwise stored in some other fashion prior to use. When used in this fashion, a length of clamping element 13 can be measured to compliment the peripheral edge area 12 of the cutout portion of cap 10.

To install window frame assembly 15 according to this first embodiment of the invention, clamping element 13 is first positioned on mounting frame 15a such that clamping surface 16 is positioned within slot 13a. Here it should be noted that frame 15a will have been first bent to a form which conforms to the shape of the cut-out portion in cap 10 and the window panes 21, 22 would have been placed in the respective slots 23, 25. Prior to this operation, it should also be noted that there will have been placed in slot 13b a rope 14 whose use is later referred to and whose diameter at least slightly exceeds the slot space adjacent edge 13c. Window frame assembly 15 once so assembled is then placed in position in the cutout portion of cap 10 so as to engage the entire peripheral edge area 12 of cap 10. When the window frame assembly 15 is in place, the installer presses the window frame assembly 15 against peripheral edge area 12 and begins removing the rope 14 or other removable material positioned in slot 13b. As the rope 14 is removed from slot 13b the slat sides depending from edge 13c of clamping element 13 are separated so that peripheral edge area 12 of cap 10 can be positioned within slot 13b. This procedure is followed around the entire periphery of the cutout portion of cap 10 to thereby install window frame assembly 15 in cap 10 as shown in FIG. 3.

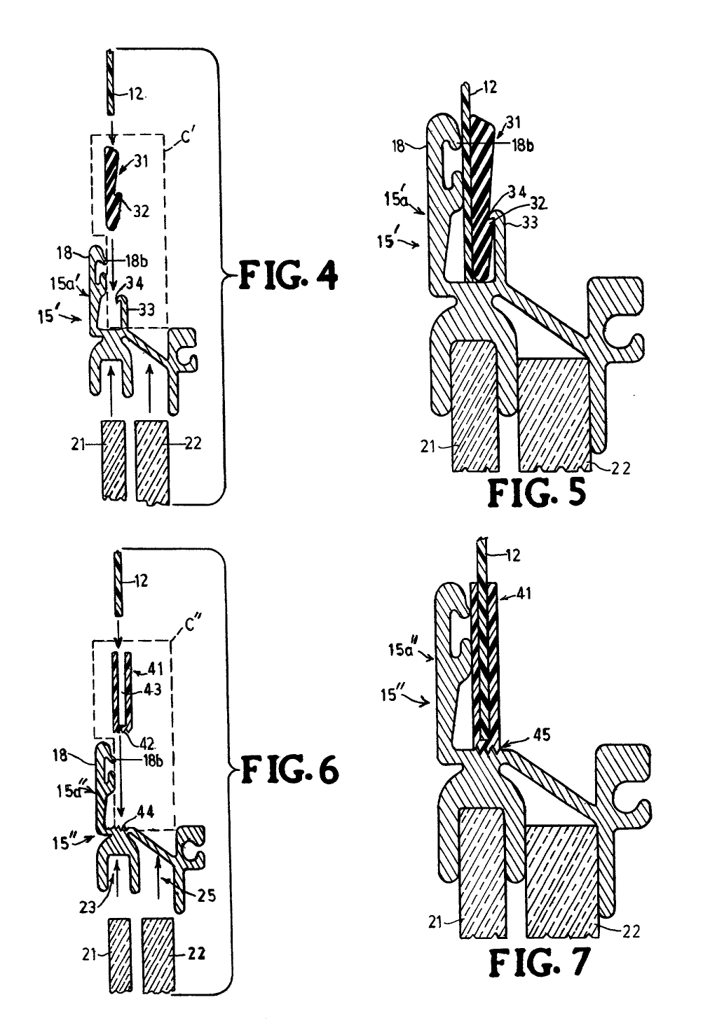

FIGS. 4 and 5 illustrate a second embodiment of the present invention in which parts similar to those of the first embodiment are designated by the same numerals but with a prime mark added. As shown in FIG. 4, mounting frame 15a′ is essentially the same as that in FIG. 2. The clamping arrangement C′ (shown in the broken line box) in this embodiment depends upon the presence of a clamping surface 33 that has an inwardly facing tooth 34. Clamping surface 33 and tooth 34 are again integrally formed on mounting frame 15a′.

Clamping element 31 is wedge-shaped and is preferably made of a pliable material such as plastic, rubber, neoprene or Santoprene™. Clamping element 31 can come as a preformed shape complimentary to the shape of peripheral edge area 12 of cap 10. Alternatively, clamping element 31 can be made of a single length of material that is rolled onto a spool or stored in some other fashion. When used as described, a length of clamping element 31 can be measured to compliment the peripheral edge area 12 of the cutout portion of cap 10. Clamping element 31 has a locking surface, illustrated as a lip 32 formed along its length.

To install window frame assembly 15′ according to this second embodiment of the invention, mounting frame 15a′ is placed in position in the cutout portion of cap 10 so as to engage the entire peripheral edge area 12 of cap 10. Here it should again be noted that mounting frame 15a′ will have been first bent to a form which conforms to the shape of the cut-out portion in cap 10 and the window panes 21, 22 would have been placed in the respective slots 23, 25. When mounting window frame assembly 15′ in place, the installer positions clamping element 31 around mounting frame 15a′ so that peripheral edge area 12 is positioned between inner face 18b′ and clamping element 31. Clamping element 31 is then wedged into the space between peripheral edge area 12 and clamping surface 33 until lip 32 engages with tooth 34 on clamping surface 33. This procedure is followed around the entire periphery of the cutout portion of cap 10 to thereby install window frame assembly 15′ in cap 10 as shown in FIG. 5.

FIGS. 6 and 7 illustrate a third embodiment of the present invention in which parts similar to those of the first embodiment are designated by the same numerals but with a double prime mark added. As shown in FIG. 6, mounting frame 15a″ is essentially the same as that in FIGS. 2 and 4. The clamping arrangement C″ (in the broken line box) in this embodiment includes a clamping surface 44 integrally formed in mounting frame 15a″. Clamping surface 44 is illustrated as a series of teeth formed on mounting frame 15a″. The specific number and shape of teeth can vary as long as there are a sufficient number to provide a secure fit to cap 10.

Clamping element 41 comprises a U-shaped insert and is preferably made of a flexible material such as plastic, rubber, neoprene or Santoprene™. Clamping element 41 includes a series of pliable teeth 42 that are adapted to engage with teeth of the clamping surface 44 on mounting frame 15a″. Clamping element 41 can come as a preformed shape complimentary to the shape of peripheral edge area 12 of cap 10. Alternatively, clamping element 41 can be made of a single length of material that is rolled onto a spool or stored in some other fashion. When used as described, a length of clamping element 41 can be measured to compliment the peripheral edge area 12 of the cutout portion of cap 10.

To install window frame assembly 15″ according to this third embodiment of the invention, clamping element 41 is positioned around the peripheral edge area 12 of cap 10. Here it should again be noted that mounting frame 15a″ will have been first bent to a form which conforms to the shape of the cut-out portion in cap 10 and the window panes 21, 22 would have been placed in the respective slots 23,25. Clamping element 41 can be frictionally fitted or otherwise adhered to the peripheral edge area 12. Once clamping element 41 is in place, mounting frame 15a″ is positioned in the cutout portion of cap 10 and pressed into the opening. As the rigid teeth of clamping surface 44 engages with the somewhat flexible teeth 42, teeth 42 initially yield and then rebound back so as to provide a mesh-type locking connection 45. This procedure is followed around the entire periphery of the cutout portion of cap 10 to thereby install window frame assembly 15″ in cap 10 as shown in FIG. 7.

The above detailed description of preferred embodiments of the invention sets forth the best mode contemplated by the inventors for carrying out the invention at the time of filing this application and is provided by way of example and not as a limitation. Accordingly, various modifications and variations obvious to a person of ordinary skill in the art to which it pertains are deemed to lie within the scope and spirit of the invention as set forth in the following claims.

What is claimed is:

1. A frame assembly for mounting a window, door or the like in an opening formed in a substantially thin wall of a vehicle structure such as a camper or truck cap, comprising:
(a) a rigid mounting frame conforming to and adapted to receive and mount on a peripheral edge area of the wall surrounding said opening and with said frame providing a mounting surface for said peripheral edge area of said wall; and
(b) a flexible clamping device positioned about the outer periphery of said frame and adapted under pressure applied thereto to be positioned so as to hold said peripheral edge area of said wall against the said mounting surface on said frame whereby to hold said frame assembly in said opening.

2. A frame assembly according to claim 1, wherein said clamping device and said frame are formed with locking surfaces adapted to engage and interlock when said frame is positioned in said opening.

3. A frame assembly according to claim 2, wherein the locking surface on said clamping device is wedge-shaped and said frame locking surface is formed to receive said wedge-shape and to be interlocked therewith when said frame is positioned in said opening.

4. A frame assembly according to claim 1, wherein said clamping device and frame are formed with teeth which intermesh when said frame is positioned in said opening.

5. A frame assembly according to claim 1, wherein said frame mounting surface defines one side of a slot the opposite side of which is defined by an opposite mounting surface and said clamping device is adapted to receive and mount said peripheral edge area of said wall within said slot.
